(19) United States
(12) Patent Application Publication
(10) Pub. No.: US 2011/0307727 A1
(43) Pub. Date: Dec. 15, 2011

(54) Computer with Built-in Wireless Module and Standby and Activate Method Thereof

(76) Inventor: Wei Wu, Guangdong (CN)

(21) Appl. No.: 13/202,573

(22) PCT Filed: Mar. 30, 2009
(86) PCT No.: PCT/CN2009/071071

§ 371 Date: Aug. 20, 2011

(30) Foreign Application Priority Data
Feb. 20, 2009 (CN) 200910037303X

(51) Int. Cl. G06F 1/32

(52) U.S. Cl. 713/323

(57) ABSTRACT

A method for activating a computer with a built-in wireless module includes the following steps: launching the activation of the computer; sending signal of requiring activation of the computer by the wireless module; and detecting, analyzing and determining the signal of requiring activation of the computer by a control circuit, sending control signal of activating the computer to the computer by the control circuit and as a response to said control signal, the computer is activated. The computer can supply electrical power to the wireless module without interruption in case that the computer gets into standby, sleep or shutdown mode. When there is incoming voice signal or data signal (for instance, short message or MMS), the voice signal or data signal may be detected, analyzed, and determined and once activation signal is found, the computer will wake up in a short time and normal hardware and software environment will resume.

### FIELD OF THE INVENTION

The invention relates to computer, telecommunication and network field and more particularly, the invention relates to a computer with built-in wireless module, standby method and activation method thereof.

### BACKGROUND OF THE INVENTION

There is stronger need than ever before for mobile office. Consumers always pursue voice communication and access to internet anywhere (such as places they often visit, for example airport, hotel, leisure plaza, coffee house, subway and suburb park) and anytime without any geographical limitation.

Two major technical solutions are employed currently for meeting the above needs. One solution involves use of palmtop (PDA) or smart phone. Imbedded software may be used to incorporate function of PDA into the mobile phone so as to perform personal information management such as management of contact persons, tasks, schedule, note and so on. In addition, under condition of narrow bandwidth network, internet applications concerning processing of word and small-sized pictures such as browsing websites and receiving and sending emails can be realized.

The other solution relates to combination of the mobile phone with a portable computer. Take as an example, a computer of X86-Architecture with powerful function may become more powerful when equipped with a wireless module and may function as a mobile phone. The wireless module is well compatible with other devices, and different type of wireless module may have different functions, for example support of multi-band, multi-network, good scalability, and the ability of being built into a main board. Moreover, the connection of the wireless module may be implemented via standard or non-standard interface and through cable or wireless manner. Dismounting and replacement of the wireless module may also be performed conveniently. A computer will certainly function as a mobile phone once provided with a wireless module.

However, much power will be consumed if the computer with built-in wireless module enters into standby mode as does the mobile phone, since the central processing unit (CPU) and chipset are kept on working all the time. Depending on size of the crystal liquid display and type of CPU, most portable computers available presently have power consumption of 20-60 watts, and some better computers such as UMPC portable computers and MID mobile internet computer may have power consumption of about 3-4 watts. The computer with the above order of power consumption can't obtain a longer standby time than a mobile phone with the power consumption of milliwatt.

The wireless module will stop working in case that the computer is in a complete standby mode (sleep mode or power-off mode) for saving power, thus data signal such as incoming voice call or short message or MMS (multimedia messaging service) being not able to be received by the computer.

Clearly, neither call nor short message will be received when the computer comes into standby mode (sleep mode or power-off mode). On the contrary, to receive and detect the incoming call and short message/MMS, the hardware, operating system and software application of the computer must be working on all the time. However, due to bottlenecks of battery technology, battery life of a general portable computer only lasts 2-4 hours which is far from a common consumer's requirement that the battery last at least 8 hours. Even if the future development of battery technology will make it possible for a battery to have endurance of more than 8 hours, the consumer's use experience will possibly be influenced due to high power consumption and high heat generation resulted from continuous operation of the battery.

### SUMMARY OF THE INVENTION

One object of the present invention is to provide a computer with built-in wireless module, a method for switching the computer into standby mode and a method for activating the computer. By the invention, the computer is capable of supplying electrical power to the wireless module continuously even when switched into standby, sleep or shutdown mode, and the computer may be activated when receiving incoming calls or data.

To realize the above object, there is provided a method for activating a computer with a built-in wireless module. The method includes the following steps.

Launching the activation of the computer;

Sending signal of requiring activation of the computer by the wireless module; and

Detecting, analyzing and determining the signal of requiring activation of the computer by a control circuit, sending control signal of activating the computer to the computer by the control circuit and as a response to said control signal, the computer is activated.

The step of launching the activation of the computer includes sending a call signal by a mobile base station to the wireless module to launch the activation of the computer when voice or data is incoming

Correspondingly, the invention provides a method for switching the computer having a built-in wireless module into standby mode. The method includes the following steps.

Launching standby of the computer;

Severing control of the wireless module by a computer system, and supplying power to the wireless module by a battery of the computer directly and independently such that the wireless module is keeping on working and the computer gets into standby mode.

The launching standby of the computer includes launching manually or automatically by the system.

Correspondingly, the invention provides a computer with a built-in wireless module. The computer further includes a control circuit by which the wireless module is connected to a computer battery. The control circuit includes a power supply management unit for controlling the computer such that the computer battery will directly supply power to the wireless module to keep on its working status when the computer comes into standby, sleep or shutdown mode. Furthermore, the wireless module includes an activation processing unit for sending a signal of requiring activation of the computer when voice or data service is incoming

The control circuit further includes a wake-up processing unit for detecting, analyzing and determining the signal of requiring computer activation and then sending control signal of activating the computer to the computer.

The control circuit may be fully or partially integrated into the wireless module. Alternatively, it may be a stand-alone component, and fully or partially be installed onto a computer main board.

The wireless module may include but not be limited to universal mobile telecommunication/CDMA, GPRS, EDGE, wide area network (containing WCDMA, TD-SCDMA, CDMA EVDO, CDMA EVDV, HSDPA, HSUPA, HSPA Plus, WiMAX, LTE, UMB, IMT-Advance, and MBWA). The interface of the wireless module may include but not be limited to mini peripheral component interconnection standard PCI E, GPRS USB, board to board interface, SD card interface SDIO, peripheral component interconnection standard PCI, portable compact flash memory or flex cable. Alternatively, the wireless module may be directly integrated into the main board of the computer, and connected to the computer through standard or non-standard interface and by cable or wireless manner.

The computer of the invention may include but not be limited to those of full series CPU under Intel X86 architecture, full series CPU under AMD X86 architecture, full series CPU under VIA X86 architecture and other computers under other X86-architecture.

The operating system of the computer includes but is not limited to all types of operating systems of Windows, Linux, UNIX and MAC.

Compared to prior art, the present invention has the following advantages.

By the invention, the computer can supply electrical power to the wireless module without interruption in case that the computer gets into standby, sleep or shutdown mode. When there is incoming voice signal or data signal (for instance, short message or MMS), the voice signal or data signal may be detected, analyzed, and determined and once activation signal is found, the computer will wake up in a short time and normal hardware and software environment will resume. In such case, the user will be prompted by ringing tone to quickly listen to the incoming call or receive the short message. Moreover, the power consumption of the computer is also reduced greatly. For example, the battery life of the computer is extended to 5 days or more time compared to 2-8 hours of prior art.

The preferred embodiments of the present invention will be discussed in detail with reference to the accompanying drawings.

### BRIEF DESCRIPTION OF THE DRAWINGS

FIG. 1 shows a prior art X86-architectured computer with a built-in wireless module; and

FIG. 2 shows a block diagram of an X86-architectured computer having a built-in wireless module according to one embodiment of the invention, illustrating that when there is incoming call or short message, the computer will resume its normal working status.

### DETAILED DESCRIPTION OF THE INVENTION

The invention makes it possible for a computer with a built-in wireless module to consume low power when in standby mode just as a mobile phone does, and to wake up the computer when there is incoming call or message. The wireless module may include but not be limited to universal mobile telecommunication/CDMA, GPRS, EDGE, wide area network (containing WCDMA, TD-SCDMA, CDMA EVDO, CDMA EVDV, HSDPA, HSUPA, HSPA Plus, WiMAX, LTE, UMB, IMT-Advance, and MBWA). The interface of the wireless module may include but not be limited to mini peripheral component interconnection standard PCI E, GPRS USB, board to board interface, SD card interface SDIO, peripheral component interconnection standard PCI, portable compact flash memory or flex cable. Alternatively, the wireless module may be directly integrated into the main board of the computer, and connected to the computer through standard or non-standard interface and by cable or wireless manner.

The computer of the invention may include but not be limited to those of full series CPU under Intel X86 architecture, full series CPU under AMD X86 architecture, full series CPU under VIA X86 architecture and other computers under other X86-architecture. The operating system of the computer includes but is not limited to all types of operating systems of Windows, Linux, UNIX and MAC.

The wake-up software for performing wake-up (or called activation) action may have the function of managing the power consumption of the wireless module and computer, as well as managing the hardware of the computer (such as CPU, fan, PCI power supply, display card, sound card and microphone).

At first, the wireless module should operate properly when the computer gets into standby mode. In addition, when the computer is in standby mode, it should be ensured that the wireless module installed inside the computer be able to communicate with the base station of a mobile network in time intervals defined in specification such as GSM or CDMA or other protocol specification. Only in such cases, the base station of the mobile network is able to determine that the wireless module works well and accordingly provides service for the module. Secondly, power consumption of the computer must be reduced effectively. In other words, it should be ensured that the CPU and relevant chipset stop working when the computer enters into standby mode (shutdown mode or sleep mode). Moreover, the computer entered into standby mode should be able to wake up. As such, the routine operation of the driver program of the wireless module under the operating system of the computer is guaranteed and accordingly, incoming call and message may be properly received.

To realize wakeup function, the wireless module may contain an activation processing unit for sending signal of requiring computer activation when there is incoming voice or data service.

Additionally, the computer of the invention further includes a control circuit by which the wireless module is connected to a computer battery. The control circuit includes a power supply management unit for controlling the computer such that the computer battery will directly supply power to the wireless module to keep on its working status when the computer comes into standby, sleep or shutdown mode. Furthermore, the wireless module includes an activation processing unit for sending a signal of requiring activation of the computer when voice or data service is incoming.

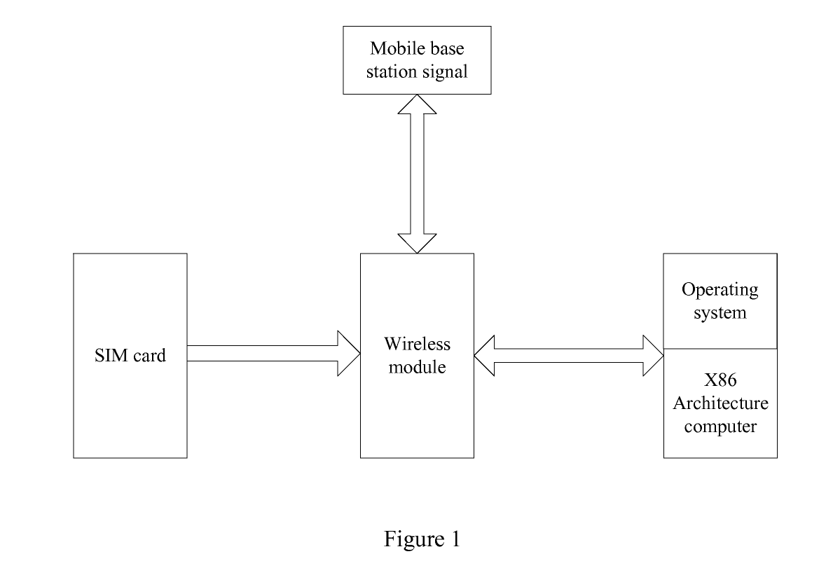

Reference is made to FIG. 1 which shows a structural diagram of an X86 architecture computer with a built-in wireless module.

At first, the wireless module reads out encrypted secret key stored on a SIM card or USIM card and then, the secret key is transferred to a base station of a mobile network such that it is verified. If verified with success, the mobile network provider will offer corresponding services. In this case, the wireless module obtains the initial data from the base station and then sends it to the computer. The driver program of the computer controls the computer so that the computer will display certain information or perform some actions. At this time, the wireless module communicates with the mobile base station (different network has different protocol specification in which the time interval for communication between the module and base station is defined so that the mobile base station can detect the status of the terminal at any time). Both the computer and wireless module are in a condition waiting for incoming call or short message. Unlike a mobile phone which consumes little power when in standby mode, the CPU and chipset of the computer still work and much power consumption is resulted. In this situation, the wireless module will be controlled by the computer and loses its communication with the mobile base station once the standby mode (shutdown or sleep mode) is performed by the operating system. As a result, the computer can't wake up.

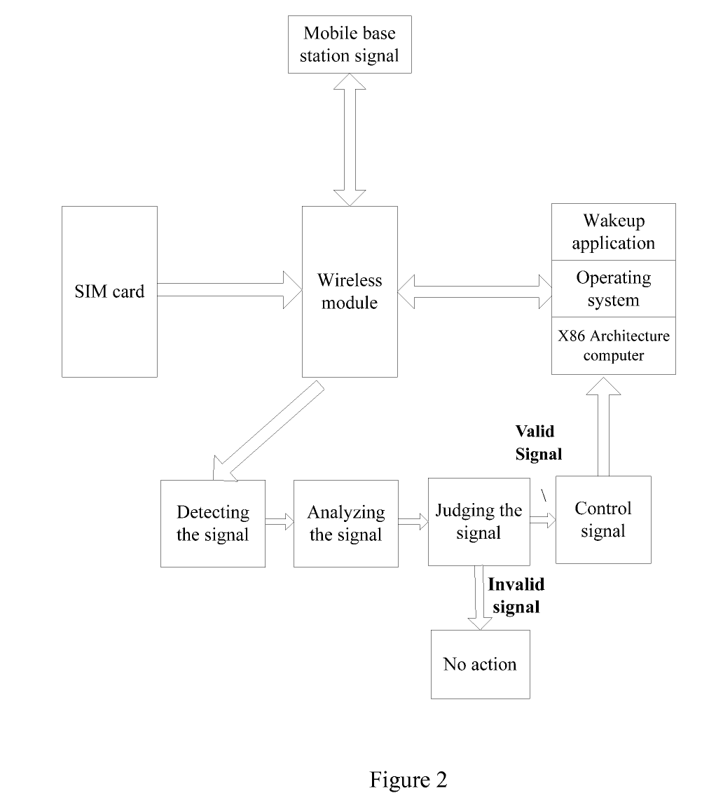

With reference to FIG. 2 which shows a block diagram of an X86-architectured computer having a built-in wireless module according to one embodiment of the invention, illustrating that when there is incoming call or short message, the computer will resume its normal working status.

In this embodiment of the invention, the computer includes a control circuit by which the wireless module is connected to a computer battery. The control circuit includes a power supply management unit for controlling the computer such that the computer battery will directly supply power to the wireless module to keep on its working status when the computer comes into standby, sleep or shutdown mode. Furthermore, the wireless module includes an activation processing unit for sending a signal of requiring activation of the computer when voice or data service is incoming.

The control circuit further includes a wake-up processing unit for detecting, analyzing and determining the signal of requiring computer activation and then sending control signal of activating the computer to the computer.

It is noted that in the present invention, to realize function such as wake-up of the computer or management of the power supply, the wireless module and respective interfaces of the control circuit may be suitably defined, depending upon the requirement of wake-up or power supply management. Accordingly, description thereof is omitted herefrom.

Further, it is also kept in mind that the control circuit may be fully or partially integrated into the wireless module. Alternatively, it may be a stand-alone component, and fully or partially be installed onto a computer main board.

In this embodiment of the invention, at first, the wireless module reads out encrypted secret key stored on a SIM card or USIM card and then, the secret key is transferred to a base station of a mobile network such that it is verified. If verified with success, the mobile network provider will offer corresponding services. In this case, the wireless module obtains the initial data from the base station and then sends it to the computer. The driver program of the computer controls the computer so that the computer will display certain information or perform some actions. At this time, the wireless module communicates with the mobile base station. Both the computer and wireless module are in a condition waiting for incoming call or short message. At this time, in case that the mobile phone is in standby mode (shutdown mode or sleep mode), or it is set through the operating system's power supply management to enter into standby mode (shutdown mode or sleep mode) after a certain period of time (for example 1 minute) and the computer actually comes into the standby mode 1 minute later, the operating system will automatically execute instructions to switch the computer into standby mode (shutdown or sleep mode). At this time, the computer no longer controls the wireless module, and then turns into standby mode (shutdown or sleep mode). The wireless module is not under the control of the computer and accordingly will not be affected by the standby mode of the computer. In this case, communication between the wireless module and mobile base station will also not be affected.

In another situation, the operating system will automatically execute instructions to switch the computer into standby mode (shutdown or sleep mode) 1 minute later. The computer performs the standby instructions of the operating system and at the same time, it sends a signal notifying the module of standby (shutdown or sleep instruction) of the computer to the wireless module. The wireless module send a requiring signal through an interface (standard or non-standard interface) connected with the control circuit to the control circuit after receiving the above notification signal. The requiring signal is detected, analyzed and judged by the control circuit and if the requiring signal is determined to be valid, then the control circuit will control the module such that power supply thereto is switched from the computer to the control circuit itself After that, the computer no longer controls the wireless module, and the computer comes into standby mode (shutdown or sleep mode). Without control of the computer, the wireless module still works due to supplying of the power. Accordingly the module will not be affected by the standby mode of the computer. In this case, communication between the wireless module and mobile base station will also not be affected.

Communication between the wireless module and mobile base station is kept on while the entire computer consumes very less power (generally at the magnitude of 0.2-0.3 W, which is several times smaller than normal power consumption).

When there is incoming call or short message, the mobile base station will send the calling signal to the wireless module and after receiving it, the module will send a requiring signal to the control circuit via the interface coupled with the control circuit (standard or non-standard interface). Here again, the requiring signal is detected, analyzed and judged by the control circuit and if the requiring signal is determined to be valid, then the control circuit will generate a control signal through an interface connected with the computer (standard or non-standard interface) and activate the computer so that the computer will return its normal working status. After waking up, the computer again controls the wireless module. The wireless module generates ringing request signal and then the ringing request signal is processed by the driver program of the computer system and finally the sound card is controlled to generate sound, thus resulting in ringing prompt. Consequently, the computer can control receiving or refusing the incoming call and short message. If no further action is performed, then the computer will again get into standby mode (shutdown mode or sleep mode) and the above procedure repeats. This not only ensures the normal operation of the wireless module, but also effectively reduces the total power consumption and heat generation resulted from continuous running of the hardware of the computer. By this way, the battery life of the computer according to the invention is increased to 5 days and more when compared with prior art battery life time of 2-8 hours.

An exemplary example of the invention is discussed below. In this example, an UMPC type of computer equipped with a wireless module of HSDPA type is provided. The UMPC is also equipped with a 4.8 inch sized touch display. The voltage of the computer's battery is 11.1 volt, and the capacity thereof is 2300 mAh. The power of the battery is approximately 25.5watt, the maximum working period of the entire computer is about 8 hours, and the power of the entire computer is about 3.2 watt. The interface of the built-in wireless module is of Mini PCI E type which benefits from removal of the module with ease at any time. Different type of wireless module may be installed to realize different wireless access function, thus facilitating scalability of the system. The computer main board and wireless module are capable of activating the computer even if the computer is in standby mode (shutdown or sleep mode). In addition, the computer is preloaded with Windows XP Professional operating system into which a wake-up application is installed to control the built-in wireless module and computer.

After the computer is powered on and completely loaded with the Windows XP operating system, the driver application of the wireless module is also loaded. Next, the wireless module performs the initialization. At first, the wireless module reads out encrypted secret key stored on a SIM card or USIM card and then, the secret key is transferred to a base station of a mobile network such that it is verified. If verified with success, the mobile network provider will offer corresponding services. In this case, the wireless module obtains the initial data from the base station and then sends it to the computer. The driver program of the computer controls the computer so that the computer will display certain information or perform some actions. At this time, the wireless module communicates with the mobile base station. Both the computer and wireless module are in a condition waiting for incoming call or short message. At this time, in case that the mobile phone is in standby mode (shutdown mode or sleep mode), or it is set through the wakeup management application to enter into standby mode (shutdown mode or sleep mode) after a certain period of time (for example 2 minute) and the computer actually comes into the standby mode 2 minute later, the Windows operating system will automatically execute instructions to switch the computer into standby mode (shutdown or sleep mode). The computer performs the standby instructions of the Windows operating system and at the same time, it sends a signal notifying the module of standby (shutdown or sleep instruction) of the computer to the wireless module. The wireless module send a requiring signal through an interface (standard or non-standard interface) connected with the control circuit to the control circuit after receiving the above notification signal. The requiring signal is detected, analyzed and judged by the control circuit and if the requiring signal is determined to be valid, then the control circuit will control the module such that power supply thereto is switched from the computer to the control circuit itself After that, the computer no longer controls the wireless module, and the computer comes into standby mode (shutdown or sleep mode). Without control of the computer, the wireless module still works due to supplying of the power. Accordingly the module will not be affected by the standby mode of the computer. In this case, communication between the wireless module and mobile base station will also not be affected. When there is incoming call or short message, the mobile base station will send the calling signal to the wireless module and after receiving it, the module will send a requiring signal to the control circuit via the interface coupled with the control circuit (standard or non-standard interface). Here again, the requiring signal is detected, analyzed and judged by the control circuit and if the requiring signal is determined to be valid, then the control circuit will generate a control signal through an interface connected with the computer (standard or non-standard interface) and activate the computer so that the computer will return its normal working status. After waking up, the computer again controls the wireless module. The wireless module generates ringing request signal and then the ringing request signal is processed by the driver program of the Windows operating system of the computer and finally the sound card is controlled to generate sound, thus resulting in ringing prompt. At this time, the user can click the touch display or press the shortcut button to receive or refuse the incoming call and the short message.

If no further action is performed, the wakeup management application will execute standby instructions after a period of time preset in the Windows XP operating system, and the above procedure repeats. This not only ensures the normal operation of the wireless module, but also effectively reduces the total power consumption and heat generation resulted from continuous running of the hardware of the computer. Experiment shows that the battery life of the computer according to the invention is significantly increased to 5 days when compared with 8 hours. In addition, heat generation is very low. The above computer of UMPC type equipped with a 4.8 inch sized touch display makes it possible to activate the Windows XP operating system when in standby mode and accordingly, this computer is definitely a strong mobile phone of computer type.

What disclosed is only preferred embodiment of the invention, and it is not intended to limit the scope of the invention to such embodiments. The invention covers all these equivalent changes made according to the invention.

What is claimed is:

1. A method for activating a computer with a built-in wireless module, comprising the following steps:
launching activation of the computer;
sending signal of requiring activation of the computer by the wireless module; and
detecting, analyzing and determining the signal of requiring activation of the computer by a control circuit, sending control signal of activating the computer to the computer by the control circuit and as a response to said control signal, the computer is activated.

2. The method according to claim 1, wherein the step of launching the activation of the computer comprises sending a call signal by a mobile base station to the wireless module to launch the activation of the computer when voice or data is incoming

3. A method for switching the computer having a built-in wireless module into standby mode, comprising the following steps:
launching standby of the computer;
severing control of the wireless module by a computer system after detection of the standby signal by a control circuit, and supplying power to the wireless module by a battery of the computer directly and independently such that the wireless module is keeping on working and the computer gets into standby mode.

4. The method according to claim 3, wherein the launching standby of the computer comprises launching manually or automatically.

5. A computer with a built-in wireless module, comprising a control circuit by which the wireless module is connected to a computer battery; the control circuit includes a power supply management unit for controlling the computer such that the computer battery will directly supply power to the wireless module to keep on its working status when the computer comes into standby, sleep or shutdown mode; the wireless module includes an activation processing unit for sending a signal of requiring activation of the computer when voice or data service is incoming; and the control circuit further includes a wake-up processing unit for detecting, analyzing and determining the signal of requiring computer activation and then sending control signal of activating the computer to the computer.

6. The computer according to claim 5, wherein the control circuit is fully or partially integrated into the wireless module; or the control circuit is a stand-alone component, and fully or partially installed onto a computer main board.

7. The computer according to claim 5, wherein the wireless module comprises universal mobile telecommunication/CDMA, GPRS, EDGE, and wide area network;
the interface of the wireless module comprises mini peripheral component interconnection standard PCI E, USB, board to board interface, SD card interface SDIO, peripheral component interconnection standard PCI, portable compact flash memory or flex cable; or the wireless module is directly integrated into the main board of the computer, and connected to the computer through standard or non-standard interface and by cable or wireless manner.

8. The computer according to claim 5, wherein the computer comprises those of full series CPU under Intel X86 architecture, full series CPU under AMD X86architecture, full series CPU under VIA X86 architecture and other computers under other X86 architecture.

9. The computer according to claim 5, wherein the operating system of the computer comprises all types of operating systems of Windows, Linux, UNIX and MAC.
